(19) United States
(12) Patent Application Publication
(10) Pub. No.: US 2024/0393614 A1
(43) Pub. Date: Nov. 28, 2024

(54) MODULAR ASSEMBLIES

(71) Applicant: Apple Inc., Cupertino, CA (US)

(72) Inventors: Brian S. LAU, Sacramento, CA (US); John RAFF, Menlo Park, CA (US); Cameron A. HARDER, San Francisco, CA (US); David A. KALINOWSKI, Davis, CA (US); Michael J. OUDENHOVEN, San Francisco, CA (US)

(21) Appl. No.: 18/693,925

(22) PCT Filed: Sep. 15, 2022
(86) PCT No.: PCT/US2022/043715

§ 371 Date: Mar. 20, 2024

Related U.S. Application Data
(60) Provisional application No. 63/248,310, filed on Sep. 24, 2021.

(51) Int. Cl. G02C 5/14; G02B 27/01; G02C 11/00

(52) U.S. Cl. CPC G02C 5/143; G02B 27/0176; G02C 11/10; G02B 2027/0178; G02C 2200/08

(57) ABSTRACT

Wearable electronic devices can include connection mechanisms for adjustable and exchangeable connections with selected modules other devices to enhance performance of the wearable electronic device. Such connections can provide both mechanical engagement and operable communication between the connected devices. Arms, earpieces, accessory devices, and/or other external devices can be easily connected to provide different components and functions at different times as desired. Accordingly, a main portion of the wearable electronic device need not include permanent components that provide every function that will later be desired by the user. Instead, the wearable electronic device can have expanded and customizable capabilities by the use of one or more arms, earpieces, accessory devices, and/or other external devices.

### CROSS-REFERENCE TO RELATED APPLICATION

This application claims the benefit of U.S. Provisional Application No. 63/248,310, entitled “HEAD-MOUNTABLE DEVICE WITH MODULAR ASSEMBLIES,” filed Sep. 24, 2021, the entirety of which is incorporated herein by reference.

### TECHNICAL FIELD

The present description relates generally to head-mountable devices, and, more particularly, to head-mountable devices with modular assemblies.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include audio output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device and an accessory device, in accordance with embodiments of the present disclosure.

FIG. 2 illustrates a top view of the head-mountable device and the accessory device of FIG. 1 with the accessory device connected to the head-mountable device, in accordance with embodiments of the present disclosure.

FIG. 3 illustrates a top view of a head-mountable device connected by an accessory device to an external device, in accordance with embodiments of the present disclosure.

FIG. 4 illustrates a top view of a head-mountable device in a partially collapsed configuration, in accordance with embodiments of the present disclosure.

FIG. 5 illustrates a sectional view of a hinge mechanism of a head-mountable device, in accordance with embodiments of the present disclosure.

FIG. 6 illustrates a sectional view of a hinge mechanism of a head-mountable device, in accordance with embodiments of the present disclosure.

FIG. 7 illustrates a top view of a head-mountable device with first earpieces installed thereon, in accordance with embodiments of the present disclosure.

FIG. 8 illustrates a top view of a head-mountable device with second earpieces installed thereon, in accordance with embodiments of the present disclosure.

FIG. 9 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mounted displays, headsets, visors, smartglasses, head-up display, etc., can perform a range of functions that is determined by the components (e.g., sensors, circuitry, and other hardware) included with the wearable device as manufactured. However, space, cost, and other considerations may limit the ability to provide every component that might provide a desired function. For example, different users may have different preferences regarding the components and functions that are provided by a given head-mountable device. Some users may desire certain capabilities, such as high-resolution display and long battery life, while other users may desire other capabilities, such as smaller form factor. Furthermore, a given user may desire different functions at different times. For example, a given user may desire high-resolution display at home and long battery life when outside the home.

Given the diversity of desired components and functions, it would be beneficial to allow a user to modify components and functions of a head-mountable device to customize the user experience according to the user's desires. Head-mountable devices of the present disclosure facilitate customization, adaptability, and modification by a user according to the user's desires.

Head-mountable devices of the present disclosure can include connection mechanisms that provide adjustable and exchangeable connections with other devices to enhance performance of the head-mountable device. Such connections can provide both mechanical engagement and operable communication between the connected devices. Arms, earpieces, accessory devices, and/or other external devices can be easily connected to provide different components and functions at different times as desired. Accordingly, a main portion of the head-mountable device need not include permanent components that provide every function that will later be desired by the user. Instead, the head-mountable device can have expanded and customizable capabilities by the use of one or more arms, earpieces, accessory devices, and/or other external devices.

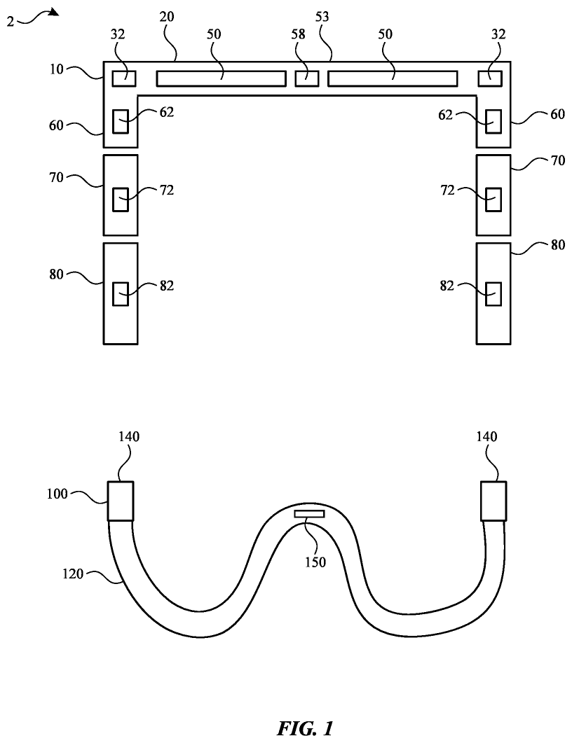

These and other embodiments are discussed below with reference to FIGS. 1-9. However, those skilled in the art will readily appreciate that the detailed description given herein with respect to these Figures is for explanatory purposes only and should not be construed as limiting.

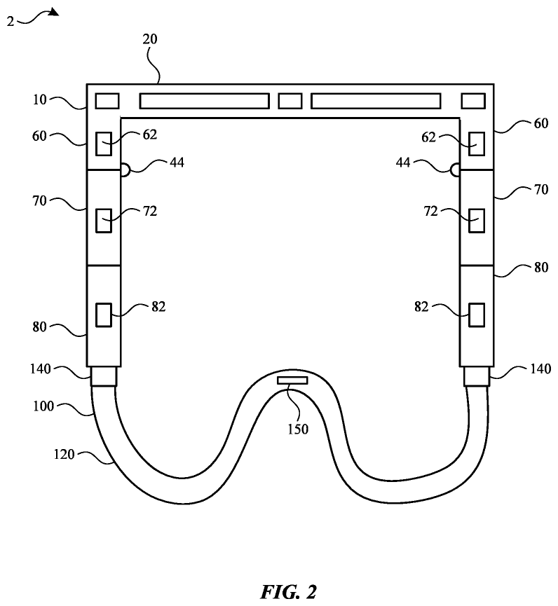

According to some embodiments, for example as shown in FIGS. 1 and 2, a system 2 can include a head-mountable device 10 that includes a frame 20 that is worn on a head with one or more arms 70 and/or earpieces 80. The frame 20 can be positioned in front of the eyes of a user to provide information within a field of view of the user. The frame 20 can provide nose pads or another feature to rest on a user's nose. The frame 20 further includes one or more optical assemblies 50 and a bridge 53 above the nose pads and connecting multiple optical assemblies 50.

The frame 20 and/or the temple portions 60 can serve to surround a peripheral region of the head-mountable device 10 as well as support any internal components in their assembled position. For example, the frame 20 and/or the temple portions 60 can enclose and support various internal components (including for example integrated circuit chips, processors, sensors, input/output devices, memory devices, and other circuitry) to provide computing and functional operations for the head-mountable device 10, as discussed further herein.

An optical assembly 50 can transmit light from a physical environment for viewing by the user. Such an optical assembly 50 can include optical properties, such lenses for vision correction based on incoming light from the physical environment. Additionally or alternatively, an optical assembly 50 can provide information as a display within a field of view of the user. Such information can be displayed based on operation of a display 62 that projects light onto and/or communicates with one or more elements of the optical assembly 50. As shown in FIG. 1, the display 62 can reside, at least partially, in one or more of the temple portions 60 and/or in the frame 20. For example, the display 62 can reside, at least partially, within a cavity extending from the frame 20 and into the temple portion 60. Displayed information can be provided to the exclusion of a view of a physical environment or in addition to (e.g., overlaid with) a physical environment. A physical environment relates to a physical world that people, such as users of head-mountable devices, can interact with and/or sense without necessarily requiring the aid of an electronic device, such as the head-mountable device. A computer-generated reality environment relates to a partially or wholly simulated environment that people sense and/or interact with the assistance of an electronic device, such as the head-mountable device. Computer-generated reality can include, for example, mixed reality and virtual reality. Mixed realities can include, for example, augmented reality and augmented virtuality. Electronic devices that enable a person to sense and/or interact with various computer-generated reality environments can include, for example, head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), tablets, smartphones, and desktop/laptop computers. A head-mountable device can have an integrated opaque display, have a transparent or translucent display, or be configured to accept an external opaque display from another device, such as a smartphone.

Referring again to FIGS. 1 and 2, a frame 20 can be supported on a user's head with the arms 70 and/or earpieces 80. The arms 70 can wrap or extend along opposing sides of a user's head, for example from a location of the temple portions 60. The arms 70 can connect to earpieces 80 for wrapping around or otherwise engaging a user's ears. It will be appreciated that other configurations can be applied for securing the head-mountable device 10 to a user's head. For example, one or more bands, straps, belts, caps, hats, or other components can be used in addition to or in place of the illustrated components of the head-mountable device 10. By further example, an arm and/or earpiece can extend about a user's head to both sides of the frame 20.

The frame 20 can be coupled to or integral (e.g., monolithic) with one or more of the temple portions 60. For example, a continuous support structure including the frame 20 can support the optical assemblies 50 as well as the displays 62. While at least a portion of the arms 70 and/or earpieces 80 can optionally move (e.g., pivot about a hinge 44) with respect to the frame 20 and/or the temple portions 60, it will be understood that, in at least some embodiments, the frame 20 and/or the temple portions 60 can form a continuous structure that supports both the optical assemblies 50 as well as the displays 62 to facilitate relative alignment of the optical assemblies 50 and their corresponding display 62. As such, the arms 70 and/or earpieces 80 can refer to at least a portion of the support structure (e.g., temple portions 60) that extends away from the portion of the frame 20 and that supports the optical assemblies 50.

In some embodiments, each of the optical assemblies 50 can include the display 62 (e.g., a light projector) and a waveguide. The display 62 can include any and all components for projecting light in the desired manner. For example, the display 62 can include light sources, such as an RGB module, polarizers, beam splitters, collimators, lenses, and the like. The optical assemblies 50 can include a waveguide that allows internal reflections of received light, as well as one or more other optical components, such as corrective lenses.

Systems 2 of the present disclosure provide a head-mountable device with an attachable, removable, and/or exchangeable accessory device 100 that provide a variety of different components and functions to achieve the results that are desired by a user. As shown in FIG. 1, the arms 70, the earpieces 80, and/or the accessory device 100 can be separate from but connectable to the frame 20 and/or the temple portions 60 to form the head-mountable device 10.

As used herein, “modular” or “module” can refer to a characteristic that allows an item, such as an arm or an earpiece, to be connected, installed, removed, swapped, and/or exchanged by a user in conjunction with another item, such as a frame of a head-mountable device. Connection of an arm or an earpiece with a frame can be performed and reversed, followed by disconnection and connection of another arm or earpiece with the same frame or another frame with the same arm or earpiece. As such, multiple arms or earpieces can be exchangeable with each other with respect to a given frame. Further, multiple frames can be exchangeable with each other with respect to a given arm or earpiece.

An arm or earpiece can be connected to a frame in a manner that allows the arm to be removed thereafter. The connection can be fully reversible, such that when the arm or earpiece and the frame are disconnected, each is restored to a condition held prior to the connection. The connection can be fully repeatable, such that after the arm, earpiece, and/or frame are disconnected, the same or a different frame and arm or earpiece set can be connected in the same way. The arm, earpiece, and/or frame can be securely and temporarily connected, rather than permanently, fixedly, or resiliently connected (e.g., via chemical and/or molecular bond). For example, connection and disconnection of the arm, earpiece, and/or frame are facilitated in a manner that does not cause permanent damage, harm, or deformation to the arm, earpiece, and/or frame.

An arm 70, an earpiece 80, and frame 20 can be connected in a manner that secures the relative positions thereof and provides a communication link there between. The secured positions and the communication link can both be achieved and maintained upon connection of the arm 70, the earpiece 80, and/or the frame 20. The secured positions and the communication link can both be removed upon disconnection of the arm 70, the earpiece 80, and/or the frame 20.

The arms 70 can optionally include one or more arm circuits 72, such as electronic circuits that provide functionality and are operably connected to the frame 20 when the arm 70 is secured to the frame 20, as described further herein. The earpieces 80 can optionally include one or more earpiece circuits 82, such as electronic circuits that provide functionality and are operably connected to the arms 70 and/or the frame 20 when the earpiece 80 is secured to the arm 70, as described further herein.

Referring again to FIGS. 1 and 2, a head-mountable device can be provided with one or more accessory devices for further enhancing functionality of the head-mountable device. For example, an accessory device 100 can be attached and operably connected, for example, to the earpieces 80. While a single accessory device 100 is shown in FIGS. 1 and 2, it will be understood that the description herein can apply to any number of accessory devices 100 simultaneously or alternately connected to the head-mountable device 10.

Accessory connectors 140 of the accessory device 100 can be located at end portions of the accessory device 100. For example, the accessory device 100 can include a pair of end portions that are connected to each other by a tether 120. Optionally, the accessory device 100 can include one or more accessory circuits 150 that provide functions to the head-mountable device 10 when connected thereto, as described further herein.

As used herein, “accessory” can refer to a characteristic that allows an item, such as an accessory device, to be connected, installed, removed, swapped, and/or exchanged by a user in conjunction with a head-mountable device. It will be understood that the head-mountable device can be operable with or without use of the accessory device and that the accessory device can provide additional functionality to the head-mountable device when installed. Connection of an accessory device with a head-mountable device can be performed and reversed, followed by disconnection and connection of another accessory device with the same head-mountable device or another head-mountable device with the same accessory device. As such, multiple accessory devices can be exchangeable with each other with respect to a given head-mountable device. Further, multiple head-mountable devices can be exchangeable with each other with respect to a given accessory device.

An accessory device can be connected to a head-mountable device in a manner that allows the accessory device to be removed thereafter. The connection can be fully reversible, such that when the accessory device and the head-mountable device are disconnected, each is restored to a condition held prior to the connection. The connection can be fully repeatable, such that after the accessory device and the head-mountable device are disconnected, the same or a different head-mountable device and accessory device pair can be connected in the same way. The accessory device and head-mountable device can be securely and temporarily connected, rather than permanently, fixedly, or resiliently connected (e.g., via chemical and/or molecular bond). For example, connection and disconnection of the accessory device and head-mountable device are facilitated in a manner that does not cause permanent damage, harm, or deformation to the accessory device or the head-mountable device.

As further shown in FIG. 2, the accessory device 100 can provide securement to a head of the user while the head-mountable device 10 is worn on the head and/or retention when the head-mountable device 10 is taken off of the head. For example, the head-mountable device 10 can be worn in front of the eyes of the user and along the sides of the user's head. The accessory device 100 can wrap around the back of the user's head with a tether 120 to secure the head-mountable device 10 from moving forward off of the user's face. By further example, the accessory device 100 can have sufficient length to drop below the user's head, such as to the back of the user's neck. In such an arrangement, the head-mountable device 10 can be taken off of the face of the user and a tether 120 of the accessory device 100 can wrap around the neck of the user and retain the head-mountable device 10 when the user intentionally or inadvertently releases it.

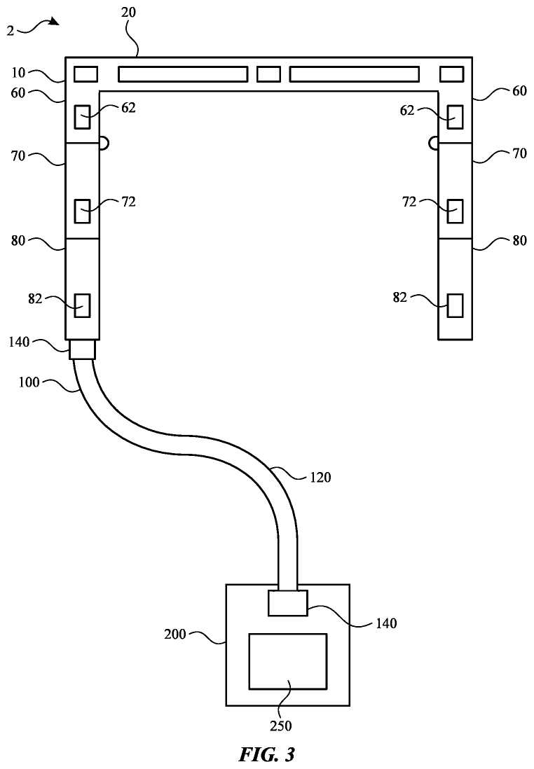

Referring now to FIG. 3, components of the head-mountable device 10 can be in operative communication with components of an external device 200 via the accessory device 100. As shown in FIG. 3, the accessory device 100 can provide the first end portion having a first accessory connector 140 that is connected to one of the earpieces 80 of the head-mountable device 10. The accessory device 100 can further provide a second end portion having a second accessory connector 140 that is connected to a connector of an external device 200. The external device 200 can include one or more external components 250 that provide functions to the head-mountable device 10 and/or the accessory device 100 when connected thereto, as described further herein.

The accessory connector 140 of the accessory device 100 that is connected to the external device 200 can be the same connector that is connectable to one of the earpieces 80 of the head-mountable device 10. As such, the same accessory device 100 can be used in multiple configurations. For example, in a first configuration such as is shown in FIG. 2, each of the accessory connectors 140 is engaged to a corresponding one of the earpieces 80 to provide operable communication between the two sides of the head-mountable device 10. By further example, in a second configuration such as is shown in FIG. 3, a first one of the accessory connectors 140 is engaged to one of the earpieces 80, and a second one of the accessory connectors 140 is engaged to the external device 200 to provide operable communication between the head-mountable device 10 and the external device 200. It will be understood that the system 2 can alternate between such arrangements to receive the benefits of either one at any given time.

While different accessory devices and/or external devices can provide different features and/or functions, multiple accessory devices and/or external devices can be exchangeable with each other by providing at least some features that are similar or the same among the multiple accessory devices and/or external devices. For example, different accessory devices and/or external devices can be secured by the same securement mechanism. By further example, different accessory devices and/or external devices can establish a communication link via the same communication mechanism. Accordingly, a head-mountable device can accommodate the exchange of different accessory devices and/or external devices by providing the same securement mechanism and communication mechanism across the different accessory devices and/or external devices. Likewise, an accessory device and/or external device can accommodate the exchange of different head-mountable devices by providing the same securement mechanism and communication mechanism across the different head-mountable devices.

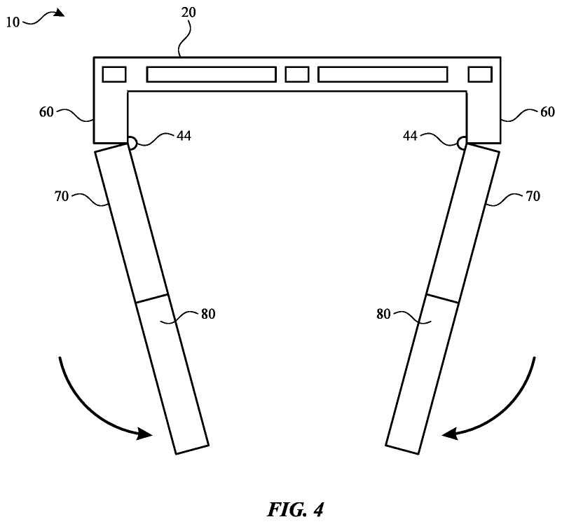

Referring now to FIG. 4, the arms and earpieces of a head-mountable device can transition between different configurations. As shown in FIG. 4, the arms 70 and the earpieces 80 can, together, pivot about a hinge 44 through which they are connected to the frame 20 (e.g., at the temple portion 60). For example, the earpieces 80 can pivot about the hinges 44 and relative to the temple portions 60 to move towards or away from each other.

In an open position of the head-mountable device (see FIG. 2), the arms 70 and the earpieces 80 can extend away from the frame 20 to provide a space for receiving a head of a user. In this position, the arms 70 and the earpieces 80 can extend in a direction that is generally similar to a direction in which the temple portions 60 extend. By further example, the arms 70 and the earpieces 80 can extend in a direction that is generally similar (e.g., parallel) to each other.

As shown in FIG. 3, the head-mountable device 10 can be moved towards and/or to a stowed position. In the stowed position, one or more of the earpieces 80 and arms 70 can be folded toward the frame 20, such that the overall space occupied by the head-mountable device 10 is minimized. In this position, the arms 70 and the earpieces 80 can be provided at an angle relative to the corresponding temple portions 60. Such angles can be smaller than in other positions, such that the arms 70 and the earpieces 80 are arranged to be transverse (e.g., perpendicular) to the temple portions 60. By further example, the arms 70 and the earpieces 80 on opposite sides can extend toward each other in the stowed position.

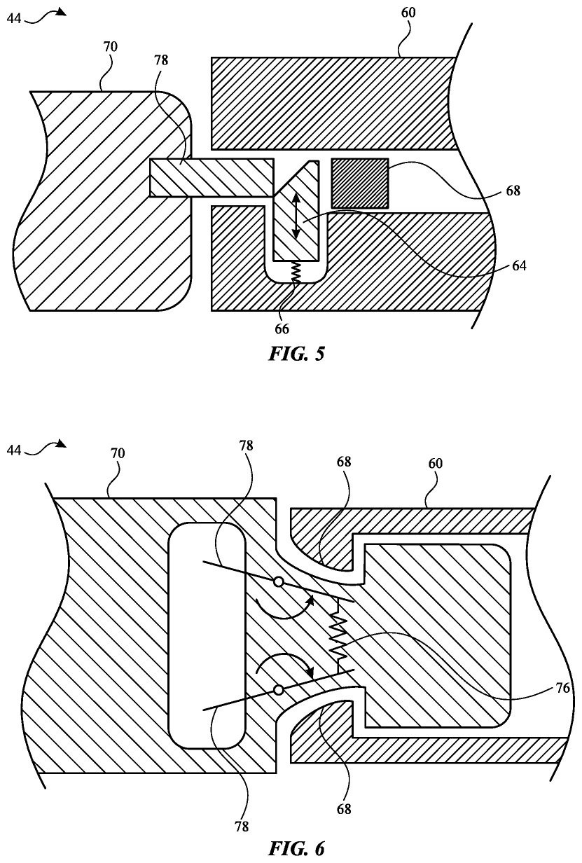

Referring now to FIGS. 5 and 6, a hinge of a head-mountable device can facilitate transitions between the various positions described herein while also providing operative communication between components on different sides of the hinge.

As shown in the embodiments illustrated in FIGS. 5 and 6, a hinge 44 can connect a temple portion 60 to an arm 70. Each of the structures on opposing sides of the hinge 44 can contain electronic circuits therein, and the hinge 44 can include connectors that operatively connect such electronic circuits. For example, the temple portion 60 and/or the frame connected thereto can include a display, an optical assembly, a processor, a camera, a sensor, and the like. By further example, the arm 70 and/or earpiece connected thereto can include a battery, a display driver, a sensor, a speaker, a microphone, and the like. It will be understood that other components, including but not limited to those described herein, can be provided on opposing sides of the hinge 44.

In the embodiment illustrated in FIG. 5, the arm 70 can include an arm connector 78 for mechanically and/or communicatively connecting to a frame connector 68 of the temple portion 60. For example, when the arm 70 engages the temple portion 60, the arm connector 78 can be brought to the frame connector 68 to establish a communication link (e.g., with contact for electrical conductivity of signals). As further shown in FIG. 5, the temple portion 60 can further include an engager 64 that is biased with a spring 66 to movably interact with the arm connector 78 of the arm 70. For example, as the arm connector 78 moves past the engager 64 to come into contact with the frame connector 68, the engager 64 can move against the bias provided by the spring 66. By further example, the engager 64 can be further biased against the arm connector 78 when fully inserted. Thereby, the engager 64 can provide a retention force to maintain engagement between the arm 70 and the temple portion 60 until the retention force is overcome.

In the embodiment illustrated in FIG. 6, the arm 70 can include one or more arm connectors 78 for mechanically and/or communicatively connecting to a frame connector 68 of the temple portion 60. For example, when the arm 70 engages the temple portion 60, the arm connector 78 can be brought to the frame connector 68 to establish a communication link (e.g., with contact for electrical conductivity of signals). As further shown in FIG. 6, the arm 70 can further include a spring 66 to movably bias the arm connectors 78 towards corresponding frame connectors 68. For example, the spring 66 can be a compression spring that biases the arm connectors 78 away from each other until they contact the frame connectors 68, which can provide a circuit to any components of the temple portion 60.

With the embodiments described herein, as the arm 70 rotates about the hinge 44 and with respect to the temple portion 60 (see FIG. 4), the mechanical engagement and the communication link between the arm connector 78 and the frame connector 68 can be maintained. As such, the components of the arm 70 and the temple portion 60 and/or the frame connected thereto remain in operable communication throughout a range of motion about the hinge 44.

It will be understood that the components and mechanisms described herein with respect to the arm 70 and the temple portion 60 can be arranged differently while still providing mechanical engagement and a communication link there between. For example, the components illustrated in FIG. 5 or 6 with respect to the temple portion 60 can be provided by the arm 70, and the components illustrated in FIG. 5 or 6 with respect to the arm 70 can be provided by the temple portion 60.

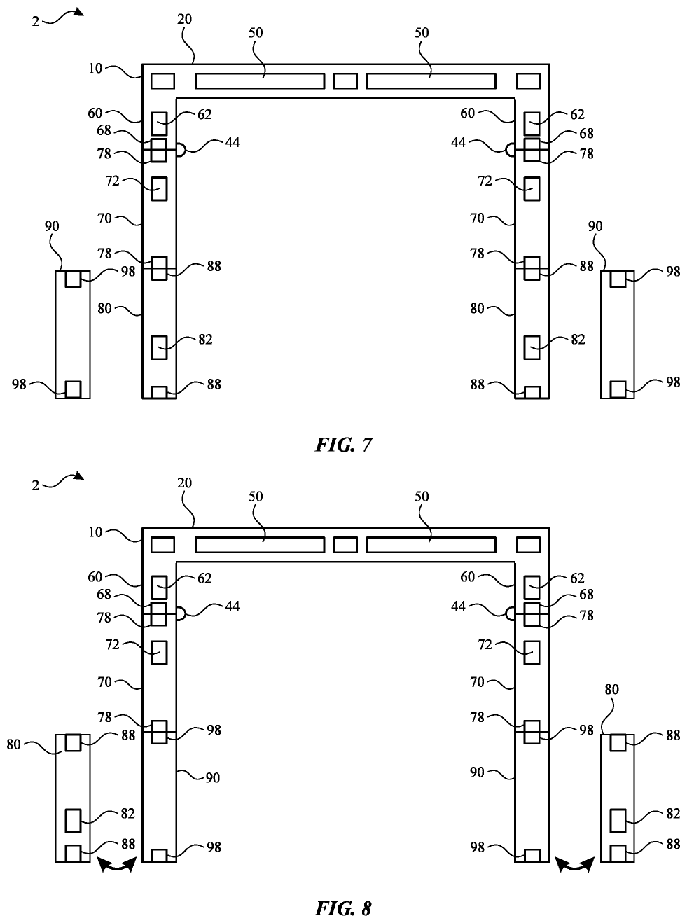

Referring now to FIGS. 7 and 8, modules of a head-mountable device can be exchanged with each other to provide various electronic circuits as desired.

While different arms 70 and earpieces 80, 90 can provide different features and/or functions, multiple arms 70 and earpieces 80, 90 can be exchangeable with each other by providing at least some features that are similar or the same among the multiple arms. For example, different arms 70 and earpieces 80, 90 can be secured to a given frame by the same securement mechanism. By further example, different arms 70 and earpieces 80, 90 can establish a communication link with the given frame 20 via the same communication mechanisms. Accordingly, a frame can accommodate the exchange of different arms 70 and earpieces 80, 90 by providing the same securement mechanism and communication mechanism across the different arms 70 and earpieces 80, 90. Likewise, arms 70 and earpieces 80, 90 can accommodate the exchange of different frames 20 by providing the same securement mechanism and communication mechanism across the different frames 20.

Systems 2 of the present disclosure provide a head-mountable device 10 with exchangeable modules that provide a variety of different components and functions to achieve the results that are desired by a user. For example, a head-mountable device 10 can be provided with earpieces 80 that can be detached from the arms 70. Arm connectors 78 of the arms 70 can interact with earpiece connectors 88 of the earpiece 80 to provide a secure and reversible coupling. The modular configurations allow a user to easily customize the head-mountable device with one or more earpieces to provide features that integrate with other operations of the head-mountable device. The earpieces 80 and 90 can be easily exchanged with each other to provide different components and functions at different times.

FIGS. 7 and 8 illustrates a top view of n assembled arms 70 and earpieces 80 each having a connector for mechanical engagement and a communication link, in accordance with some embodiments of the present disclosure. While only earpieces 80 and 90 are shown as being exchanged, it will be understood that the description herein can, in addition or alternatively, apply to exchanging arms 70.

As shown in FIG. 7, the earpieces 80 can attach to the arms 70 of the head-mountable device 10 with the arm connectors 78 and the earpiece connectors 88. For example, the arm connectors 78 and the earpiece connectors 88 can mechanically engage each other for securement of the earpieces 80 to the arms 70. The arm connectors 78 and the earpiece connectors 88 can have complementary shapes to facilitate engagement. For example, the arm connectors 78 and/or the earpiece connectors 88 can form a protrusion and the earpiece connectors 88 and/or the arm connectors 78 can form a groove. The groove can have a shape and/or size that complement the shape and/or size of the arm connectors 78. It will be understood that a variety of shapes and/or sizes can be provided to achieve the engagement between the arm connectors 78 and the earpiece connectors 88. It will be further understood that any number of arm connectors 78 and earpiece connectors 88 can be provided. While certain mechanical attachment mechanisms are depicted, it will be understood that other mechanical attachment mechanisms are also contemplated.

One or more of a variety of mechanisms can be provided to lock the earpieces 80 in place with respect to the arms 70. For example, mechanisms such as slides, locks, latches, snaps, screws, clasps, threads, magnets, pins, an interference (e.g., friction) fit, knurl presses, bayoneting, and/or combinations thereof can be included to lock the earpieces 80 to the arms 70 when the arm connectors 78 and the earpiece connectors 88 engage each other. The earpieces 80 can remain locked from sliding with respect to the arms 70 until a release mechanism is actuated. The release mechanism can be provided on an outer surface of the head-mountable device 10 for access by a user. For example, the release mechanism can be provided on an outer surface of the arms 70 and/or the earpieces 80. Where a locking mechanism locks the earpieces 80 in place with respect to the arms 70, the release mechanism, when actuated, can move and act upon the locking mechanism to cause it to release. For example, the release mechanism, when actuated, can release one or more locks, latches, snaps, screws, clasps, threads, magnets, pins, an interference (e.g., friction) fit, knurl presses, bayoneting, and/or combinations thereof that were previously locking the earpieces 80 to the arms 70. At least some of the interactions between the release mechanism and a locking mechanism can be within the arms 70 and/or the earpieces 80.

The arm connectors 78 and earpiece connectors 88 can be provided with a communication interfaces, such as pairs of conductive contacts that are configured to make electrical contact when the arms 70 and the earpieces 80 are coupled together. For example, one or more of the communication interfaces of the arm connectors 78 and earpiece connectors 88 can include a moveable element for making an electrical connection, such as a pogo pin that is at least partially collapsible and/or a contact pad that is at least partially flexible. By further example, a pogo pin can be spring loaded and/or a contact pad can be formed from an electrically conductive foam or elastomer. Additionally or alternatively, the communication interfaces of the arm connectors 78 and earpiece connectors 88 can include connectors that are manually connected to establish a communication interface apart from the mechanical engagement. Optionally, the communication interfaces can form waveguides for conducting light between the arms 70 and the earpieces 80. It will be understood that a variety of other communication links can be provided, such as those requiring no direct contact to establish a communication link. For example, a communication link can include wireless interfaces, Bluetooth interfaces, Near Field Communication interfaces, magnetic interfaces, inductive interfaces, resonant interfaces, capacitive coupling interfaces, Wi-Fi interfaces, optical interfaces, acoustic interfaces, and/or other communication interfaces.

It will be understood that the electronic circuits of the different modules can be operably connected to each other through a communication link. For example, the earpiece circuits 82 can be operably connected to the arm circuits 72 and/or other components of the head-mountable device (e.g., at the frame 20) via the arm connectors 78 and earpiece connectors 88. As such, the electronic circuits can operate in concert with each other.

As shown in FIG. 8, different earpieces can be exchanged with each other at different times to assemble a different head-mountable device. Different earpieces can provide a variety of different components and functions to achieve the results that are desired by a user.

As shown in FIG. 8, the earpieces 80 can be removed by detachment from the arms 70. Another earpiece 90 can be provided to each of the arms 70. In some embodiments, the earpieces 90 can omit or lack an electronic circuit. As such, the earpieces 90 can have a lighter weight and smaller size, and the user can select such an earpiece 90 when no additional electronic circuit or corresponding function is required or desired.

While the earpiece 90 may omit electronic circuits, the earpiece 90 can connect to the corresponding arm 70 with the same mechanical securement as with the earpiece 80. For example, as shown in FIG. 8, the earpieces 90 can attach to the arms 70 of the head-mountable device 10 with the arm connectors 78 and the earpiece connectors 98. For example, the arm connectors 78 and the earpiece connectors 98 can mechanically engage each other for securement of the earpieces 90 to the arms 70. The earpiece connectors 98 can have features described herein with respect to the earpiece connectors 88 of the earpiece 80. For example, mechanisms provided by the earpiece connectors 98 can include slides, locks, latches, snaps, screws, clasps, threads, magnets, pins, an interference (e.g., friction) fit, knurl presses, bayoneting, and/or combinations thereof can be included to lock the earpieces 90 to the arms 70 when the arm connectors 78 and the earpiece connectors 98 engage each other.

In some embodiments, where no electronic circuit is included with the earpieces 90, the earpieces 90 may not provide operable functionality to the head-mountable device beyond structural support and engagement to the head of the user. Accordingly, neither the earpiece connectors 98 nor another component of the earpieces 90 may provide a communication link with the arms 70. As such, the mechanical coupling can be achieved without a communication link for operable connections.

In some embodiments, the earpieces 90 or another earpiece can be exchanged with the earpieces 80 to provide different electronic circuits and different functionality to the head-mountable device 10. In such assemblies, the new earpieces can establish a communication link with the arms 70 and/or other components of the head-mountable device 10.

Multiple modules can have other features that are similar or the same among the multiple modules. For example, the multiple modules can include enclosures that have the same or similar size, shape, profile, dimension, aspect ratio, surface feature, texture, color, and/or markings. The common features allow a user to exchange the modules with each other while maintaining a consistent user experience across the different modules when used at different times.

Additionally or alternatively, at least one of the size, shape, profile, dimension, aspect ratio, surface feature, texture, color, and/or markings can be different among multiple frames. For example, different frames can have different sizes and/or shapes to accommodate different head and/or face structures. This can allow a user to choose from among multiple frames that provide different ergonomic features so the user can select one according to comfort provided. By further example, different frames can provide different functional features, such as different lenses for vision correction, so that a user can select a frame that is appropriate for a given activity (e.g., driving, reading, etc.). By further example, different frames can have different aesthetic features to provide the user with different options for fashion and appearance.

Additionally or alternatively, at least one of the size, shape, profile, dimension, aspect ratio, surface feature, texture, color, and/or markings can be different among multiple arms. For example, different arms can have different sizes and/or shapes to accommodate different head and/or face structures. This can allow a user to choose from among multiple arms that provide different ergonomic features so the user can select one according to comfort provided. By further example, different arms can have different aesthetic features to provide the user with different options for fashion and appearance.

The modules can be positioned at a location that enhances the comfort of the combined system 2 to the user when worn. For example, the arms 70 and/or earpieces 80 can be positioned to engage the head and/or ears of the user and optionally provide a counter-balance to the weight of certain components of the head-mountable device 10. One or more electronic circuits and/or non-electronic circuits of the accessory device 100 can provide the desired weight so that the weight of the combined system 2 is distributed to enhance the comfort of the user.

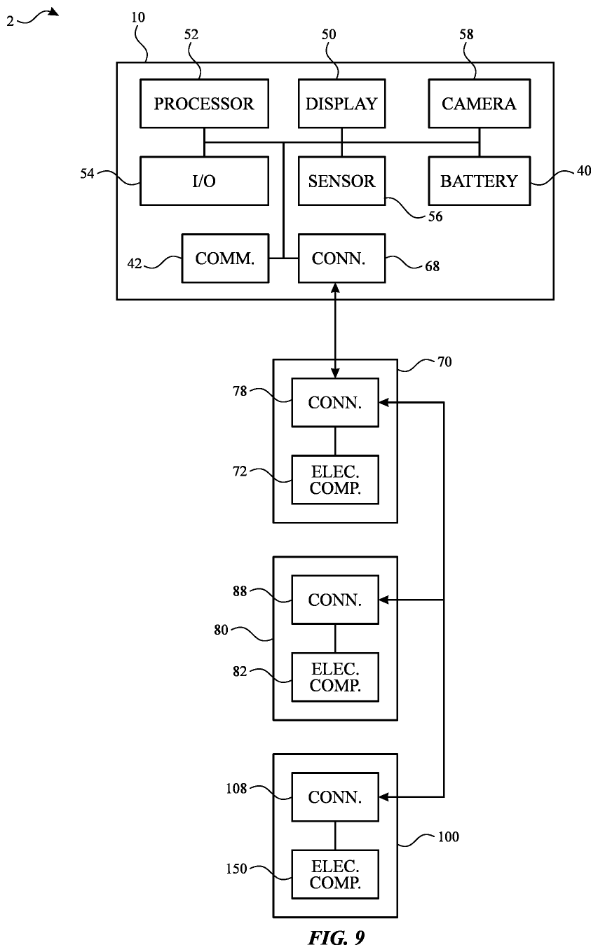

FIG. 9 illustrates a block diagram of a system including a head-mountable device, an arm, an earpiece, and/or an accessory device, in accordance with some embodiments of the present disclosure. It will be appreciated that components described herein can be provided on one or more of the head-mountable device, arm, earpiece, and/or accessory device. In some embodiments, components are provided by an arm, earpiece, and/or accessory device instead of a head-mountable device to reduce redundancy and increase customization based on a selection of accessory devices.

As shown in FIG. 9, the head-mountable device 10 can include a processor 52 with one or more processing units that include or are configured to access a memory having instructions stored thereon. The instructions or computer programs may be configured to perform one or more of the operations or functions described with respect to the head-mountable device 10. The processor 52 can be implemented as any electronic device capable of processing, receiving, or transmitting data or instructions. For example, the processor 52 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements. The memory can store electronic data that can be used by the head-mountable device 10. For example, the memory can store electrical data or content such as, for example, audio and video files, documents and applications, device settings and user preferences, timing and control signals or data for the various modules, data structures or databases, and so on. The memory can be configured as any type of memory. By way of example only, the memory can be implemented as random access memory, read-only memory, Flash memory, removable memory, or other types of storage elements, or combinations of such devices.

The head-mountable device 10 can include a camera 58 for capturing a view of an environment external to the head-mountable device 10. The camera 58 can include an optical sensor, such as a photodiode or a photodiode array. Additionally or alternatively, the camera 58 can include one or more of various types of optical sensors that are arranged in various configurations for detecting user inputs described herein. The camera 58 may be configured to capture an image of a scene or subject located within a field-of-view of the camera 58. The image may be stored in a digital file in accordance with any one of a number of digital formats. In some embodiments, the head-mountable device 10 includes a camera, which includes an image sensor formed from a charge-coupled device (CCD) and/or a complementary metal-oxide-semiconductor (CMOS) device, a photovoltaic cell, a photo resistive component, a laser scanner, and the like. It will be recognized that a camera can include other motion sensing devices.

The head-mountable device 10 can include one or more frame circuits 32, such as electronic circuits that provide functionality and are operably connected to other components, as described further herein. Examples of frame circuits 32 are described further herein and include (but are not limited to) processors, memory, sensors, communication interfaces, input/output devices, and the like.

The head-mountable device 10 can further include an optical assembly 50 for displaying visual information for a user. The optical assembly 50 can provide visual (e.g., image or video) output. The optical assembly 50 can be or include an opaque, transparent, and/or translucent display. A transparent or translucent optical assembly 50 may have a medium through which light representative of images is directed to a user's eyes. The optical assembly 50 may utilize digital light projection, OLEDs, LEDS, uLEDs, liquid crystal on silicon, laser scanning light source (e.g., display 62), or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

The head-mountable device 10 can include an input/output component 54, which can include any suitable component for connecting head-mountable device 10 to other devices. Suitable components can include, for example, audio/video jacks, data connectors, or any additional or alternative input/output components. The input/output component can include buttons, keys, or another feature that can act as a keyboard for operation by the user. As such, the description herein relating to keyboards can apply to keyboards, keys, and/or other input features integrated on the head-mountable device 10. Such an input/output component can be fixedly or removably attached to a display of the head-mountable device 10.

The head-mountable device 10 can one or more sensors 56 may also include various sensors that detect conditions pertaining to the user, the head-mountable device 10, and/or the head engager. For example, in addition to the camera 58, the head-mountable device 10 may include motion sensors, such as one or more of accelerometers, gyroscopes, magnetometers, inertial measurement units (IMU), cameras, or the like, which measure conditions pertaining to the position and/or orientation of the head of the user and/or the head-mountable device 10. The sensor 56 can include one or more eye sensors for tracking features of the user wearing the head-mountable device 10, including conditions of the user's eye (e.g., focal distance, pupil size, etc.). For example, such sensors can perform facial feature detection, facial movement detection, facial recognition, eye tracking, user mood detection, user emotion detection, voice detection, etc. For example, an eye sensor can optically capture a view of an eye (e.g., pupil) and determine a direction of a gaze of the user. The head-mountable device 10 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc.

The head-mountable device 10 can include a battery 40, which can charge and/or power components of the head-mountable device 10. The battery 40 can also charge and/or power components connected to the head-mountable device 10.

The head-mountable device 10 can include communications interface 42 for communicating with one or more servers or other devices using any suitable communications protocol. For example, communications interface can support Wi-Fi (e.g., a 802.11 protocol), Ethernet, Bluetooth, high frequency systems (e.g., 900 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. A communications interface 42 can also include an antenna for transmitting and receiving electromagnetic signals.

The head-mountable device 10 can include an frame connector 68 for communicating with the arm 70 via the arm connector 78 to provide operable (e.g., communicative) connections between the components of each. The head-mountable device 10 can provide one or more frame connectors 68 for communicating with a corresponding number of arms 70.

As further shown in FIG. 9, arms 70 can include one or more arm circuits 72 (e.g., electronic circuits) to perform selected functions and to interact with the head-mountable device 10. The arm 70 can include an arm connector 78 (e.g., a different arm connector 78 that connects to the frame connector 68) for communicating with the earpiece 80 via the earpiece connector 88 of the earpiece 80 to provide operable (e.g., communicative) connections between the components of each.

As further shown in FIG. 9, earpieces 80 can include one or more earpiece circuits 82 (e.g., electronic circuits) to perform selected functions and to interact with the head-mountable device 10. The earpiece 80 can include an earpiece connector 88 (e.g., a different earpiece connector 88 that connects to the arm connector 78) for communicating with the accessory device 100 via an accessory connector 108 of the accessory device 100 to provide operable (e.g., communicative) connections between the components of each.

Each of the arms 70, earpieces 80, and/or accessory devices 100 can be controlled at least in part by the processor 52 of the head-mountable device 10. For example, while the arms 70, earpieces 80, and/or accessory devices 100 are connected to the head-mountable device 10, the processor 52 of the head-mountable device 10 can operably connect to and/or control one or more components of the arms 70, earpieces 80, and/or accessory devices 100 via the communication links provided by the connectors.

Additionally or alternatively, the head-mountable device 10 can be controlled at least in part by the arms 70, earpieces 80, and/or accessory devices 100. For example, while the arms 70, earpieces 80, and/or accessory devices 100 are connected to the head-mountable device 10, the arms 70, earpieces 80, and/or accessory devices 100 can operably connect to and/or control one or more components of the head-mountable device 10 via the communication link provided by the connectors.

In some embodiments, the arm 70, earpiece 80, and/or accessory device 100 can operate as a power source for the head-mountable device 10. By providing power with a removable accessory device, the user can select such an accessory device according to anticipated power needs. The accessory circuit 150 can include a battery that is used to store and provide power to the head-mountable device 10 and/or the accessory device 100. Optionally, the arm 70, earpiece 80, and/or accessory device 100 can recharge the battery 40 of the head-mountable device 10, for example, by directing power from the accessory circuit 150 (e.g., battery) across the frame connector 68. Other pathways are contemplated, such as another link or wireless charging. The battery can be a replaceable battery, a rechargeable battery. Additionally or alternatively, the accessory circuit 150 can be a tethered power source that receives power from a source external to the accessory device 100, such as from a USB cable, Lightening cable, or other interface. One or more batteries of the head-mountable device can transfer power to and/or receive power from another device. Such power transfer can be wired and/or wireless.

Further examples of arm circuits 72, earpiece circuits 82, and/or accessory circuits 150 include speakers. Such speakers can be operated in concert with or independently of the speakers of the head-mountable device 10. Speakers of the arm 70, earpiece 80, and/or accessory device 100 can be provided and operated at locations that enhance the audio output of the combined system 2. For example, the speakers of the arm 70, earpiece 80, and/or accessory device 100 can be operated to provide spatial audio to the user.

Further examples of arm circuits 72, earpiece circuits 82, and/or accessory circuits 150 include cameras. Such cameras can be operated in concert with or independently of the cameras 130 of the head-mountable device 10. Cameras of the arm 70, earpiece 80, and/or accessory device 100 can be provided and operated at locations that enhance the visual capture capabilities of the combined system 2. For example, the cameras of the arm 70, earpiece 80, and/or accessory device 100 (optionally with the cameras 58 of the head-mountable device 10) can be operated in concert to capture a combined image that spans a wide field of view. For example, the field of view can be greater than 90°, 180°, 270°, or up to 600°. Images captured by one or more of the cameras of the arm 70, earpiece 80, and/or accessory device 100 can be displayed on the optical assembly 50 of the head-mountable device 10.

Further examples of arm circuits 72, earpiece circuits 82, and/or accessory circuits 150 include microphones. Such microphones can be operated in concert with or independently of microphones of the head-mountable device 10. Microphones of the arm 70, earpiece 80, and/or accessory device 100 can be provided and operated at locations that enhance the audio capture capabilities of the combined system 2. For example, the microphones of the arm 70, earpiece 80, and/or accessory device 100 can be operated to capture directional audio from an environment of the user.

Further examples of arm circuits 72, earpiece circuits 82, and/or accessory circuits 150 include sensors. By providing sensing capabilities with a removable module, the user can select such an accessory device 100 and/or an external device 200 when sensing particular conditions is desired. Such sensors can be configured to sense substantially any type of characteristic such as, but not limited to, images, pressure, light, touch, force, temperature, position, motion, and so on. For example, the sensor may be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. The sensor can be used to sense ambient conditions in a neighboring environment. The sensor can be provided with exposure to the environment, for example with an opening in the arm 70, earpiece 80, and/or accessory device 100.

Further examples of arm circuits 72, earpiece circuits 82, and/or accessory circuits 150 include bio-sensors. By providing bio-sensing capabilities with a removable module, the user can select such an accessory device 100 and/or an external device 200 when tracking biometric characteristics, such as health and activity metrics, is desired. The one or more bio-sensors can include optical and/or electronic biometric sensors that may be used to compute one or more biometric characteristics. For example, a bio-sensor can include a light source and a photodetector to form a photoplethysmography (PPG) sensor. An optical (e.g., PPG) sensor or sensors may be used to compute various biometric characteristic including, without limitation, a heart rate, a respiration rate, blood oxygenation level, a blood volume estimate, blood pressure, or a combination thereof. One or more of the bio-sensors may also be configured to perform an electrical measurement using one or more electrodes. The electrical sensor(s) may be used to measure electrocardiographic (ECG) characteristics, galvanic skin resistance, and other electrical properties of the user's body. Additionally or alternatively, a bio-sensor can be configured to measure body temperature, exposure to UV radiation, and other health-related information.

Further examples of arm circuits 72, earpiece circuits 82, and/or accessory circuits 150 include user sensors. Such sensors can be used to detect features relating to the user wearing the head-mountable device and/or other individuals. For example, user sensors can perform facial feature detection, facial movement detection, facial recognition, eye tracking, user mood detection, user emotion detection, voice detection, etc.

Further examples of arm circuits 72, earpiece circuits 82, and/or accessory circuits 150 include components for receiving input from a user, providing output to a user, and/or performing other functions. Examples of such components include a speaker, a microphone, a display, a touch sensor, a haptic device, a camera, an optical sensor, a magnet, a gyroscope, an accelerometer, and/or another I/O component. The I/O components can be used to detect and interpret user inputs. The I/O components can be used to provide information to the user. The I/O components can also be used to capture information relating to the user and/or the environment.

Examples of arm circuits 72, earpiece circuits 82, and/or accessory circuits 150 include display drivers. By providing display drivers with a removable module, the user can select such an accessory device 100 and/or external device 200 when certain display features are desired. Such display drivers can be configured to control the optical assembly 50 of the head-mountable device 10.

Additionally or alternatively, the head-mountable device 10 can alter one or more parameters of its operations based on the presence, absence, or other condition of a given one of the arms 70, earpieces 80, and/or accessory devices 100. For example, when one of the arms 70, earpieces 80, and/or accessory devices 100 is installed, the head-mountable device 10 may perform an action the utilized the functions of the arm 70, earpiece 80, and/or accessory device 100. By further example, when the arm 70, earpiece 80, and/or accessory device 100 is absent, the head-mountable device 10 may perform an action that does not rely on the functions of the absent arm 70, earpiece 80, and/or accessory device 100. Additionally or alternatively, the head-mountable device 10 may perform actions in a manner that consumes power based on the presence, absence, and/or amount of power provided by the arms 70, earpieces 80, and/or accessory devices 100. For example, the head-mountable device 10 can perform an action with greater power consumption (e.g., high-resolution display output, enhanced audio and/or imaging processing, communication with external devices) when a battery of the arms 70, earpieces 80, and/or accessory devices 100 is present and sufficiently charged, and the head-mountable device 10 can perform an action with lower power consumption (e.g., low-resolution display output, reduced audio and/or imaging processing, reduced communication with external devices) or refrain from performing such an action when a battery of the the arms 70, earpieces 80, and/or accessory devices 100 is absent or not sufficiently charged.

It will be recognized that the difference in functionality between arms, earpieces, accessory devices, and/or external devices can refer to both the purpose of a component as well as the parameters of its operation. For example, while the components of different arms, earpieces, accessory devices, and/or external devices can both be for a common purpose, the components can operate differently to achieve the purpose. For example, different components can be for sensing different conditions based on the operations desired by a user. Other variations, such as size, shape, and material selection can be provided so the user can select the arm, earpiece, accessory device, and/or external device that is best suited for the user's comfort and/or performance of the component.

The different arms, earpieces, accessory devices, and/or external devices can also differ in mechanical configuration such as material properties and/or structural features, which can help define shape, size, flexibility, rigidity, tactile feel, and/or aesthetic properties such as color, patterns, and/or materials to provide a different look and feel. Furthermore, each of the arms, earpieces, accessory devices, and/or external devices may have a different enclosure having a different color, material, shape, accoutrements, patterns, etc. The enclosures can provide different aesthetic features, cosmetic features, and/or a look and feel than the other enclosures in the system.

While the components of different arms, earpieces, accessory devices, and/or external devices can differ, at least some can have the same or similar connectors, including communication interfaces, so that each can attach to and communicate with the same head-mountable device in the same or similar manner.

Accordingly, each arm, earpiece, accessory device, and/or external device is configured to provide a different function and/or aesthetic feature than one or more other components in the system. As such, the user can select the arm, earpiece, accessory device, and/or external device with the desired functionality and/or look and feel. This may be at the time of purchase, thus allowing differentiation from other purchasers, or it may be that all or some portion of the arm, earpiece, accessory device, and/or external device come in a set such that the user can select the desired one for the right moment. In one example, one set of modules may be configured for use outside the home, while another may be configured for use at home. Any combination of aesthetic and functional features may be provided to create a different head-mountable device. When combined with the different head-mountable devices, the system becomes highly customizable. The user can create a different head-mountable device by selecting one head-mountable device to go along with one set of arms, earpieces, accessory devices, and/or external devices. If multiple systems are provided, any number of different head-mountable device configurations can be made.

Accordingly, embodiments of the present disclosure provide a head-mountable devices that include connection mechanisms for adjustable and exchangeable connections with selected modules other devices to enhance performance of the head-mountable device. Such connections can provide both mechanical engagement and operable communication between the connected devices. Arms, earpieces, accessory devices, and/or other external devices can be easily connected to provide different components and functions at different times as desired. Accordingly, a main portion of the head-mountable device need not include permanent components that provide every function that will later be desired by the user. Instead, the head-mountable device can have expanded and customizable capabilities by the use of one or more arms, earpieces, accessory devices, and/or other external devices.

Various examples of aspects of the disclosure are described below as clauses for convenience. These are provided as examples, and do not limit the subject technology.

Clause A: a head-mountable device comprising: a frame comprising a display; arms configured to be releasably and operably coupled to the frame, wherein each of the arms is pivotable with respect to the frame; earpieces each configured to be releasably and operably coupled to a corresponding one of the arms; and an accessory device configured to be releasably and operably coupled to at least one of the earpieces.

Clause B: a head-mountable device comprising: a frame comprising a frame connector; and an arm comprising an arm connector configured to releasably engage the frame connector to couple the arm to the frame and allow the arm to rotate with respect to the frame, the arm connector being further configured to maintain an operable connection with the frame connector throughout rotation of the arm with respect to the frame.

Clause C: a system comprising: a frame comprising: a frame electronic circuit; a frame connector; and an arm comprising: a first arm connector configured to releasably engage the frame connector; and a second arm connector; a first earpiece comprising: an earpiece electronic circuit; and a first earpiece connector, wherein the earpiece electronic circuit is configured to be operably connected to the frame electronic circuit via the arm when, while in a first arrangement of the system, the first earpiece connector releasably engages the second arm connector; and a second earpiece comprising a second earpiece connector configured to releasably engage the second arm connector in a second arrangement of the system without providing a communication link between the second earpiece and the arm.

One or more of the above clauses can include one or more of the features described below. It is noted that any of the following clauses may be combined in any combination with each other, and placed into a respective independent clause, e.g., Clause A, B, or C.

Clause 1: the arms comprise: a first arm; and a second arm; and the earpieces comprise: a first earpiece operably coupled to the first arm; and a second earpiece operably coupled to the second arm.

Clause 2: the frame supports a processor; and the accessory device further comprises an accessory circuit, wherein, when the accessory circuit is configured to be operably coupled to the processor through at least one of the earpieces and at least one of the arms.

Clause 3: the accessory circuit comprises a sensor. Clause 4: the accessory circuit comprises a battery.

Clause 5: the accessory device comprises accessory connectors at opposing ends of the accessory device.

Clause 6: the accessory device is configured to be arranged in: a first configuration with each of the accessory connectors engaged to a corresponding one of the earpieces; and a second configuration with a first one of the accessory connectors engaged to a first one of the earpieces and a second one of the accessory connectors engaged to an external device to provide operable communication between the external device and the first one of the earpieces.

Clause 7: the head-mountable device further comprises: a camera supported by the frame; an eye sensor supported by the frame; speakers supported by the arms; and batteries supported by the earpieces.

Clause 8: one of the frame connector and the arm connector are biased by a spring against the other of the frame connector and the arm connector.

Clause 9: one of the arm connector is a first arm connector, the arm comprises a second arm connector, and the first arm connector and the second arm connector are biased away from each other to engage the frame connector.

Clause 10: an earpiece configured to be releasably and operably coupled to the arm and rotate with the arm and with respect to the frame.

Clause 11: the frame connector is a first frame connector; the arm is a first arm; the arm connector is a first arm connector; the frame comprises a second frame connector; and the head-mountable device further comprises a second arm comprising a second arm connector configured to releasably engage the second frame connector to couple the second arm to the frame.

Clause 12: the frame further comprises: an optical assembly; and a temple portion extending away from the optical assembly, the temple portion containing a light projector directed toward the optical assembly, the temple portion supporting the frame connector.

Clause 13: the first arm connector is configured to allow the arm and the first earpiece to rotate with respect to the frame, wherein the first arm connector is further configured to maintain an operable connection with the frame connector throughout rotation of the arm with respect to the frame.

Clause 14: the second earpiece further comprises an additional earpiece connector configured to releasably engage an accessory device.

Clause 15: the earpiece electronic circuit is a battery.

Clause 16: the frame electronic circuit is a first processor; and the earpiece electronic circuit is a second processor.

Clause 17: the first earpiece has a size and shape that is identical to a size and shape of the second earpiece.

As described herein, aspects of the present technology can include the gathering and use of certain data. In some instances, gathered data can include personal information or other data that can uniquely identify or be used to locate or contact a specific person. It is contemplated that the entities responsible for the collection, storage, analysis, disclosure, transfer, or other use of such personal information or other data will comply with well-established privacy practices and/or privacy policies. The present disclosure also contemplates embodiments in which users can selectively block the use of or access to personal information or other data, which can be managed to minimize risks of unintentional or unauthorized access or use.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a frame comprising a display;
arms configured to be releasably and operably coupled to the frame, wherein each of the arms is pivotable with respect to the frame;
earpieces each configured to be releasably and operably coupled to a corresponding one of the arms; and
an accessory device configured to be releasably and operably coupled to at least one of the earpieces.

2. The head-mountable device of claim 1, wherein:
the arms comprise:
a first arm; and
a second arm; and
the earpieces comprise:
a first earpiece operably coupled to the first arm; and
a second earpiece operably coupled to the second arm.

3. The head-mountable device of claim 1, wherein:
the frame supports a processor; and
the accessory device further comprises an accessory circuit, wherein the accessory circuit is configured to be operably coupled to the processor through at least one of the earpieces and at least one of the arms.

4. The head-mountable device of claim 3, wherein the accessory circuit comprises a sensor.

5. The head-mountable device of claim 3, wherein the accessory circuit comprises a battery.

6. The head-mountable device of claim 1, wherein the accessory device comprises accessory connectors at opposing ends of the accessory device.

7. The head-mountable device of claim 6, wherein the accessory device is configured to be arranged in:
a first configuration with each of the accessory connectors engaged to a corresponding one of the earpieces; and
a second configuration with a first one of the accessory connectors engaged to a first one of the earpieces and a second one of the accessory connectors engaged to an external device to provide operable communication between the external device and the first one of the earpieces.

8. The head-mountable device of claim 1, wherein the head-mountable device further comprises:
a camera supported by the frame;
an eye sensor supported by the frame;
speakers supported by the arms; and
batteries supported by the earpieces.

9. A head-mountable device comprising:
a frame comprising a frame connector; and
an arm comprising an arm connector configured to releasably engage the frame connector to couple the arm to the frame and allow the arm to rotate with respect to the frame, the arm connector being further configured to maintain an operable connection with the frame connector throughout rotation of the arm with respect to the frame.

10. The head-mountable device of claim 9, wherein at least one of the frame connector and the arm connector are biased by a spring against the other of the frame connector and the arm connector.

11. The head-mountable device of claim 9, wherein the arm connector is a first arm connector, the arm comprises a second arm connector, and the first arm connector and the second arm connector are biased away from each other to engage the frame connector.

12. The head-mountable device of claim 9, further comprising an earpiece configured to be releasably and operably coupled to the arm and rotate with the arm and with respect to the frame.

13. The head-mountable device of claim 9, wherein:
the frame connector is a first frame connector;
the arm is a first arm;
the arm connector is a first arm connector;
the frame comprises a second frame connector; and
the head-mountable device further comprises a second comprising a second arm connector configured to arm releasably engage the second frame connector to couple the second arm to the frame.

14. The head-mountable device of claim 9, wherein the frame further comprises:
an optical assembly; and
a temple portion extending away from the optical assembly, the temple portion containing a light projector directed toward the optical assembly, the temple portion supporting the frame connector.

15. A system comprising:
a frame comprising:
a frame electronic circuit; and
a frame connector; and
an arm comprising:
a first arm connector configured to releasably engage the frame connector; and
a second arm connector;
a first earpiece comprising:
an earpiece electronic circuit; and
a first earpiece connector, wherein the earpiece electronic circuit is configured to be operably connected to the frame electronic circuit via the arm when the first earpiece connector releasably engages the second arm connector; and
a second earpiece comprising a second earpiece connector configured to releasably engage the second arm connector without providing a communication link between the second earpiece and the arm.

16. The system of claim 15, wherein the first arm connector is configured to allow the arm and the first earpiece to rotate with respect to the frame, wherein the first arm connector is further configured to maintain an operable connection with the frame connector throughout rotation of the arm with respect to the frame.

17. The system of claim 15, wherein the second earpiece further comprises an additional earpiece connector configured to releasably engage an accessory device.

18. The system of claim 15, wherein the earpiece electronic circuit is a battery.

19. The system of claim 15, wherein:
the frame electronic circuit is a first processor; and
the earpiece electronic circuit is a second processor.

20. The system of claim 15, wherein the first earpiece has a size and a shape that is identical to a size and a shape of the second earpiece.
